(19) United States
(12) Patent Application Publication
(10) Pub. No.: US 2006/0223041 A1
(43) Pub. Date: Oct. 5, 2006

(54) Video game with learning metrics

(75) Inventors: John Christen Beck, Phoenix, AZ (US); Adam Thomas Carstens, Scottsdale, AZ (US)

Correspondence Address: LEWIS AND ROCA LLP, 40 NORTH CENTRAL AVENUE, PHOENIX, AZ, 85004, US

(73) Assignee: North Star Leadership Group, Inc., Phoenix, AZ (US)

(21) Appl. No.: 11/096,348

(22) Filed: Apr. 1, 2005

(51) Int. Cl. G09B 5/00

(52) U.S. Cl. 434/307 R

(57) ABSTRACT

A video game teaches a player through game play, assesses the player's learning, and determines how fast the player is learning and whether the player is learning faster. The learning assessment is used to determine how fast the player is learning, and the determination of how fast the player is learning is used to determine whether the player is learning faster. Alternatively, a video game player performs one or more attempts to overcome a challenge corresponding to the satisfaction of a predetermined game condition. A learning award is derived for each attempt where the predetermined game condition is satisfied based upon the player's performance in satisfying the game condition. A learning velocity is derived as a function of change in the learning award from a different attempt. A learning acceleration can also be derived for each attempt as a function of change in the learning velocity.

### TECHNICAL FIELD

The present invention relates generally to video games, and more particularly to a video game having learning metrics.

### BACKGROUND

Video games typically identify when a player satisfies a game condition. For instance, the game condition can be deemed to have been satisfied when the player operates a game controller to control the movements of a virtual warrior to fight and weaken, disable, or destroy a virtual enemy that is controlled by artificial intelligence (e.g., by instructions executed by a processor of the video game console). Some video games give a numerical reward (e.g., points) when the game condition is satisfied. Few video games keep more than cursory track of changes in the player's performance with repeated play of the video game. It would be an advance in the art to extensively report changes in the player's performance.

Video games can be a structured, simplified, limited version of reality in which a challenge is presented to a player. Through game play, the player overcomes the challenge in order to win the game. As such, it would be an advance in the video game arts to provide a video game that presented a reality-like challenge to the player during game play, where the challenge had been designed to teach the player a principle or concept that would be useful to the player in real life, and to extensively report on the player's learning of that principle or concept.

### SUMMARY

Implementations provide a video game that teaches a player through game play and that assesses the player's learning of the teaching. A determination is made as to how fast the player is learning and whether the player is learning faster. The player's learning assessment can be used to determine how fast the player is learning, and the determination of how fast the player is learning can be used to determine whether the player is learning faster. Players can play alone, against each other or on a team against other teams.

Implementations provide for a video game that reports a player's performance in satisfying a game condition by reporting the effort taken by the player to satisfy the game condition (“effort measurement”), and by reporting changes in the player's effort measurement with experience in playing of the video game. Reporting can be used by others in evaluating the player against others, against a standard, and against players on a team that includes the player.

Implementations provide for a video game that teaches a player a principle or concept that is useful to the player in real life through presenting a reality-like challenge to the player during game play. The player is deemed to have learned the principle or concept when the player overcomes the challenge, where the player is deemed to have overcome the challenge when the player's game play satisfies a game condition. As the player continues to satisfy the game condition during additional game play, a report is made of the rate or ‘velocity’ of the player's learning of the principle or concept. Changes in the velocity of the player's learning are reported as the ‘acceleration’ of the player's learning. As such, the video game logically equates the velocity and acceleration of the player's satisfaction of the game condition, respectively, with the velocity and acceleration of the player's learning of the principle or concept that the video game was designed to teach.

Implementations provide for a video game system that includes a game console having memory and a processor, an input device compatible with the game console, and a video game executed on the game console to receive input from the input device controller to control one or more player-selected activities of a virtual actor having images thereof displayed in the video game. One or more player-selected activities are initiated in respective one or more attempts to satisfy a predetermined game condition. When the one or more player-selected activities of one attempt satisfy the predetermined game condition, a learning award and a learning velocity are derived. The learning award is derived as a function of the control of one or more player-selected activities. The learning velocity is derived as a function of change in the learning award derived for another attempt and the number of attempts.

### BRIEF DESCRIPTION OF THE DRAWINGS

A more complete understanding of the implementations may be had by reference to the following detailed description when taken in conjunction with the accompanying drawings wherein:

FIGS. 1A and 1B each depicts a flowchart illustrating an exemplary video game process for accumulating learning metrics for a single player and for a team, respectively;

FIGS. 2A-2C each depicts a graph illustrating learning metrics accumulated for a single player playing a video game;

FIGS. 3A-3C each depicts a graph illustrating learning metrics accumulated for a team of players during play of a video game;

FIGS. 4a-4h depict progressive scenes from a video game during which learning metrics are accumulated for a player making a first attempt to overcome a challenge during play of the video game;

FIGS. 5a-5f depict progressive scenes from a video game during which learning metrics are accumulated for a player making a second attempt to overcome a challenge during play of the video game;

FIG. 6 illustrates a plurality of systems for playing video games, the systems being in communication through a network on which multiple players can play a video game as a team or against one another;

FIG. 7 is a screen shot from a video game featuring an enemy from the perspective of a virtual character that is controlled by a player of the video game;

FIG. 8 shows a plurality of screen shots from the video game of FIG. 7;

FIG. 9 is a table giving formulas relative to a player's choice and performance of activities and actions when attempting to overcome a challenge in video game;

FIG. 10 is a table showing exemplary calculations, using the formulas in the table of FIG. 9, that correspond to a player's sequential actions in first and second attempts to overcome a challenge, where the player's sequential actions in the first and second attempts is depicted, respectively, in FIGS. 4a-4h and FIGS. 5a-5f.

### DETAILED DESCRIPTION

Implementations of a video game are disclosed as reporting on the satisfaction of a game condition by a player that plays the video game. The game condition can be deemed to have been satisfied, for instance, when the player operates a game controller to control the movements of a virtual warrior in a fight to weaken, disable, or destroy a virtual enemy. The virtual enemy can be controlled by another player or by artificial intelligence (AI). Control by the AI results from instructions executed by a processor of the platform that is running the video game (e.g., a personal computer, cellular telephone, set top box, video game console, etc.). The video game awards a numerical reward (e.g., points) when the game condition is satisfied. The video game can keep track of, and report on, changes in the player's performance with repeated play of the video game. The effort that is taken by the player to satisfy the game condition (“effort measurement”) is measured. Reports can then be made as to any changes in the player's effort measurement, including the changes in the player's effort measurement (e.g., velocity of the change), and changes in the velocity (acceleration). As the player becomes more experienced in playing of the video game, the effort measurement and any changes thereto can be reported upon and monitored to evaluate the player against other players, against a standard, and against players on a team that includes the player.

Implementations of the video game are presented as a structured, simplified, limited version of reality. In this virtual reality, a challenge is presented to a player. Through game play, the player overcomes the challenge in order to win the game. The challenge that is presented to the player is designed to teach the player so that the player will learn a principle or concept (e.g., using the video game as a teaching tool). The principle or concept that the player can learn through the virtual reality of game play can be designed so as to be useful to the player in some specific aspect of real life. For instance, the principle or concept to be learned by the player can be an aspect of owning and operating a business, customer service, economics, finance, etc. As such, the game teaches the player a principle or concept that is useful to the player in real life through presenting a reality-like challenge to the player during game play. The player is deemed to have learned the principle or concept when the player overcomes the challenge (e.g., the player has demonstrated learning of an identified business principle that the video game was designed to teach). In turn, the player is deemed to have overcome the challenge when the player's satisfies a game condition. As the player continues to satisfy the game condition during additional game play, a report is made of the rate or ‘velocity’ of the player's learning of the principle or concept. Changes in the velocity of the player's learning are reported as the ‘acceleration’ of the player's learning. As such, the video game logically equates the velocity and acceleration of the player's satisfaction of the game condition, respectively, with the velocity and acceleration of the player's learning of the principle or concept that the video game was designed to teach. Accordingly, through presenting to the gamer the reality-like challenge during game play, statistics can be accumulated and reports made as to the dynamics of the player's learning against others, against a standard, and against players on a team that includes the player.

Implementations of the video game allow the player to take one or more actions in an attempt to satisfy a game condition. Each attempt consists of a series of actions by the player that may or may not satisfy the game condition. An ‘action’ is deemed to have been taken when a log of one or more inputs to an input device by the player matches or otherwise corresponds to an entry in a table of ‘actions’. That is, when the input device log has a respective entry in a table containing actions that can be taken by the player during game play, an action is deemed to have taken place.

The player is deemed to have satisfied a game condition during an attempt when a recording of the actions taken by the player during the attempt (e.g., a log of the player's actions) matches or otherwise corresponds to an entry in a table of ‘satisfied game conditions’. That is, when the player's action log has a respective entry in a table containing satisfied game conditions taken by the player during game play, a ‘successful attempt’ is deemed to have taken place. When the game condition is a challenge designed to teach a business principle to the player, then a ‘success’ means that the player has demonstrated learning of the business principle. Thus, the player operates the input device to perform specific actions to successfully overcome the challenge so as to satisfy the game condition, thereby constituting a demonstration that the player has figured out or learned the identified business principle that the video game was designed to teach.

When an attempt by the player to satisfy the game condition succeeds, various metrics can be collected and reported. One such metric is the number of actions that the player took to satisfy the game condition. This metric can be understood as a measurement of how fast the player demonstrated learning of the identified business principle, or as the velocity of the player's learning. Another metric is the difference between the actions taken by the player to satisfy the game condition and an ideal number of actions. This metric can be understood as assessing whether the player is a fast learner when compared to a predetermined standard.

After the player has repeatedly satisfied the game condition in a plurality of attempts while playing the video game, a metric can be taken of the changes in the actions that the player requires to satisfy the game condition. In particular, the metric can point out whether there has been a statistically significant decrease in the number of actions that the player takes to satisfy the game condition. This metric can be understood as conveying whether the player is learning faster, whether the velocity of the player's learning is changing, or whether the player's learning is accelerating.

Given the accumulation of the foregoing metrics for a plurality of players, comparisons can be made from one player to another. For instance, it can be determined whether the average quantity of actions that one player required to satisfy the game condition is less than that of other players. This metric can be understood as assessing whether the player is a faster learner than the other players, or whether the player's velocity of learning is the highest when compared to that of others.

Given that each player's velocity of learning is known, changes in the velocity can also be known. Then, it can be determined whether a player's rate of decrease in the average number of actions to success (e.g., to satisfy a game condition) is a faster rate of decrease than that of another player. That is, it can be known if the quantity of one player's actions leading to success are decreasing faster than that of the other players, or whether the rate at which the player's learning is accelerating is greater than the other players. Stated otherwise, the metric answers the query of whether the increase in the learning rate of the identified business concept demonstrated by the player is greater than that of the other players.

Though the average number of actions that one player needs to satisfy the game condition may be greater than that of other team members, the player's learning may still show significant promise. Such promise might be shown by a statistically significant decrease in the number of actions needed to succeed, which decrease is greater for this player than the decrease found for the other players. This metric can be understood to shown that the player's acceleration in learning exceeds that of the other players.

When players are playing the video game as a team, the performance of one team player can be compared to that of other team players. As before, the performance is measured by the number of actions required by the player to satisfy a game condition. With the assessment of the performance metrics for each player on the team, it can be shown which players are the faster learners on the team. It can also be shown whether the increase in the rate of learning of the identified business concept demonstrated by the player is greater than that of other team players.

When the average number of actions that the player needs to satisfy the game condition may be greater than that of other team members, the player may yet show promise. For instance, the decrease in the player's actions needed to succeed (e.g.; to satisfy the game condition) may be greater than for that of the other team members. A larger decrease by this player can be understood as meaning that the rate at which this player is learning is increasing faster than the rate of increase in learning by the other team players.

One team's performance can be compared against another's or even against a standard. For instance, the difference can be determined between the actions taken by one team to satisfy the game condition and an ideal number of actions. Stated otherwise, it can be determined whether one team is faster at learning than a recognized standard of what ‘fast’ means. Also, a difference can be determined as between the actions taken by one team to satisfy the game condition and the other teams with respect to their respective velocities of learning and accelerations in the learning.

Challenge; Action; Activity; Resource; Level; Setting; Location

Implementations of the video game incorporate concepts of challenges, actions, activities, resources, levels, settings, locations, and resources. Implementations permit a player to play skillfully in the choice and performance of one or more predetermined activities to overcome a challenge (e.g.; to satisfy a game condition). The challenge is designed to be an opportunity for the player to learn a principle or concept that is useful in real life (e.g.; a learning opportunity). When the challenge is overcome by the player's choice and performance of activities, a game condition will have been logically satisfied, and the player is deemed to have learned the principle or concept. Both the choice and the performance of each activity expend scarce resources. When an activity is chosen, an ‘action’ counter is incremented. During game play, as the player makes an attempt to complete a challenge, the value of the action counter increases and the remaining amount of resources decreases. An ‘attempt’ counter is incremented each time that the player is unsuccessful or successful at completing a challenge. The attempt counter increases in values until the player successfully complete the challenge. The video game has several levels. Each level has at least one challenge that is staged in settings, where there can be various locations within each setting.

The player's goal is to complete all learning opportunities in all levels (e.g., to overcome each challenge, or to satisfy each game condition) to achieve a high score. More importantly, however, the video game is designed to assess the player's learning of certain key concepts and to place metrics on the dynamics of the player's learning, include the velocity at which the player is learning, and whether the player's learning is accelerating. These metrics correspond to the skill with which the player chooses and performs each activity in response to each challenge presented by each learning opportunity. Each challenge is designed to be an opportunity for the player to learn one or more of the key concepts. As such, the measurement of the player's skill in responding to challenges corresponds to the player's learning of the key concepts.

For instance, a video game designer may program a game so that, by playing the game, players will learn excellence in providing guest services in the operation of a vacation property. Successful guest services in the operation of a vacation property may require that a player learn certain key concepts. For instance, these key concepts may include having an adequate revenue from operating the vacation property (Income), obtaining and maintaining talented staff to provide a variety of luxurious and fun services to the guests (Talents), establishing and enriching warm and sensitive feelings by the staff towards the guests (Relationships), using creativity in employing staff, Talents, and resources to solve tricky problems inherent in guess relations (Innovations), and reinforcing guest loyalty so that past guests are likely to return periodically to the vacation property (Longevity). Accordingly, each challenge encountered in playing the video game will be designed to assess, based on the response to the challenge, the player's learning of one or more of the following key concepts: Income, Talents, Relationships, Innovations, and Longevity.

Measurements are made continuously of the player's response to challenges with repeated game play. These continued measurements are used to both statically and dynamically quantify the player's learning into the following assessments: the degree to which a key concept had been learned, changes in the degree of learning, and the rate of changes in the degree of learning. Stated otherwise, the player's collective responses to challenges through repeated game play puts a metric on the player's learning of each key concept (“Learning”), the rate at which the player learns (Learning Velocity), and the changes in the rate at which the player learns (Learning Acceleration).

The video game will preferably be designed to confront a player with a challenge. The player makes one or more attempts to overcome the challenge. The player overcomes the challenge when a game condition is satisfied. The challenge is specifically designed to assess the player's learning of a principle or concept. When the player's performance in responding to the challenge is poor (e.g.; takes too long, uses too many resources; fails to protect important valuables; frequent failures to act when expedient), the video game awards the player with a relatively small number of points or credits. When the player's performance in responding to the challenge is good, the video game awards the player with a larger number of points or credits. As the player plays the video game and is repeatedly confronted with challenges, the player's learning of the principles or concepts will tend to increase because the video game is designed to teach these principles or concepts through confronting the player with challenges in game play. An increase in the player's learning, as used herein, is the player's velocity of learning. When a player's velocity of learning changes, the player's learning accelerates. Learning acceleration shows the change in learning velocity with the number of attempts that the player has taken. Since velocity of learning, in some implementations, can be measured by the number of Points (Pt) per Attempts (At), then the Velocity of learning is calculated as Pt/At. As such, the acceleration is measures as Pt/At/At or Pt/At², which can be both positive and negative.

By way of example of the foregoing, a player may perform a response the first time that a challenge is encountered that achieves a numerical assessment of “2”, where the challenge was designed to teach the key concept of Talents. As such, the Talent Learning assessment is “2” for the Talent key concept. The next five (5) times that a challenge teaching the key concept of Talents is encountered by the player, the player achieves progressively higher numerical assessments in the Talent Learning assessment. For instance, the player might double the assessment with each attempt (e.g., 4, 8, 16, 32, 64).

At the sixth (6^{th}) Talents challenge, the Talent Learning Velocity can be calculated as the sixth Talent Learning assessment divided by the number of attempts to overcome the Talent challenges (e.g., 2/1=2; 4/2=2; 8/3=2.7; 16/4=4; 32/5=6.4; 64/6=10.7). The Talent Learning Acceleration assessment is calculated by dividing the Talent Learning Velocity by the number of attempts to overcome the Talent challenges (e.g.; 2/1/1=2; 4/2/2=1; 8/3/3=0.9; 16/4/4=1.0; 32/5/5=1.3, 64/6/6=1.8).

Implementations provide a video game in which a player's performance in playing the video game provides input to the video game. When instructions for the video game are executed, a player of the video game is presented with a challenge that is overcome. The challenge is overcome when the player's input satisfies a predetermined game condition. Input is received from the player in each of a plurality of attempts to overcome the challenge. For each attempt, a learning award and a learning velocity is derived. The learning award is derived as a function of the input received from the player to overcome the challenge. The learning velocity is derived as a function of change in the learning award derived for another attempt and the number of attempts that have been made by the player, and the learning acceleration is derived as a function of change in the learning velocity.

By way of example, the learning velocity can derived by dividing the learning award by the total number of attempts and the learning acceleration can be derived by dividing the learning velocity by the total number of attempts. Alternatively, or in addition, the derivation of the learning award can also be a function of the amount of resources that had been used by the player for the player to overcome the challenge, such as by comparing the amount to a predetermined amount of resources. Where for each said attempt the input received from the player to overcome the challenge initiates one or more activities, the derivation of the learning velocity can further be a function of the number of activities initiated by the player to overcome the challenge.

The input received from the player in each said attempt to overcome the challenge can be subjected to a psychometric test by use of a psychological measurement to derive the learning award. It is contemplated that the psychometric test would assess the player's learning of a principle or concept that the challenge was designed to teach the player.

Once the learning velocity and learning acceleration are derived using tables, formulas, equations, the foregoing being objective and/or subjective criteria as implemented by the video game designer, a report can be made of the player's learning velocity and learning acceleration. The report can be by player, by player as compared to another player, by team on which the player is member, by team as compared to another team, etc.

The learning assessments examples given above are analogous to the concepts of displacement, velocity, and acceleration, where displacement is a measure of distance, velocity is the time rate of change in displacement, and acceleration is the time rate of change in velocity. Rather than being based upon distance and time, the learning assessments described herein are based upon a measure of the player's responses to a challenge that is designed to assess the player's learning of a key concept. Each key concept that the video game has been designed to teach is similarly assessed. As such, the video game provides, for each of a plurality of key concepts, a tool to gauge a player's learning, velocity of learning, and acceleration of learning.

From the foregoing assessments, a particular style of learning on the part of the player may be characterized. For instance, the player's responses to different kinds of challenges may show that the player aggressively ignores any hint of formal instruction, that the player leans heavily on trial and error, and that the player learns skills in small increments when the player so desires—such as just before the skill is needed.

While the above given example provides different ways of measuring learning, including learning velocity and acceleration, still other ways of measuring learning are also contemplated. For instance, each challenge can be designed to assess the player's learning of multiple key concepts. Depending upon how the player chooses to respond the challenge, the assessment of the player's learning of each key concept can be numerically effected in a different way—some for the better and some for the worse.

In yet another alternative, the player's chosen response to the challenge can cause scarce resources to be used economically or wastefully as the player attempts to overcome the challenge. As such, a weighting based upon the player's use of resources can be placed upon the player's learning assessment for each relevant key concept. The weight applied to each key concept learning assessment can be based upon the difference between the actual resources used and a predetermined ideal number of resources that should have been used by the player's chosen response. Still further, the velocity of the player's learning, as calculated above, can be further weighted by the difference between the actual number of chosen activities performed by the player to overcome a challenge and a predetermined ideal number of activities that should been chosen and performed by the player to overcome the challenge.

In exemplary implementations of the above alternatives, certain metrics can be placed upon a player's learning of various real world principles and concepts. By way of further explanation, and not by way of limitation, principles and concepts of operating a resort are used in an illustration of video game play through presenting reality-like challenges to the player during game play. Assessments are made of the player's learning of the principles or concepts by the way that the player overcomes the challenges. These assessments include a Learning Challenge Assessment (lₙ); a Velocity of Learning (vₙ); and an Acceleration of Learning (rₙ), each of which are defined below.

Implementations of the video game can measure the Learning Challenge Assessment (lₙ) by computing [(INC)*(TAL)*(REL)*(INN)*(LNG)]+(hₐ)−(hᵢ)]; where lₙ is a value representing an assessment of a player's response to a challenge, where the value is based upon the player's choice of an activity and how the player performs the chosen activity. This challenge in the video game is used to assess the player's learning of each of the key concepts of Income, Talent, Relationships, Innovation, and Longevity; where INC is the Income Learning Assessment, TAL is the Talent Learning Assessment; REL is the Relationships Learning Assessment; INN is the Innovation Learning Assessment; LNG is the Longevity Learning Assessment; where ha is the actual resources used to overcome Challenge (lₙ), where hᵢ is the predetermined ideal number of resources that should have been used to overcome Challenge (lₙ); where the weighting of resource usage for each chosen activity is used upon the forgoing learning assessments; where the particular numerical effect that any chosen activity that is performed by the player can have on resources is accounted for, and where each Learning Assessment (e.g., INC, TAL, REL, INN, and LNG) can be derived from an equation that may or may not use time as a factor, can each be a table look up value, or combination thereof, within the discretion of the video game designer. In particular, the value of the Learning Assessment, its velocity and its acceleration can be arrived at using both objective and subjective factors. For instance, a challenge presented to a player can be designed to solicit a response to which psychometric tests can be applied by use of psychological measurements to arrive at one or more Learning Assessments.

Implementations of the video game can measure the Velocity of Learning (vₙ) as the change in the Learning Challenge Assessment (Δl=lₙ−lₙ₋₁) between successive actions (jₙ, jₙ₋₁)=(lₙ−lₙ₋₁)/(jₐ/jᵢ). In these implementations, each action can be one or more activities that the player chooses and then performs, where ja is the actual number of actions chosen and performed by the player to overcome Learning Challenge Assessment (lₙ); jᵢ is a predetermined ideal number of actions that should been chosen and performed by the player to overcome Learning Challenge Assessment (in); and where neither jₐ, jᵢ, nor vₙ are calculated until jₐ=jᵢ. Here, for instance, a high value in the Velocity of Learning (vₙ) may indicate that the player is a fast learner in the area of one or more of the Learning Assessments (e.g., INC, TAL, REL, INN, and LNG).

Implementations measure the Acceleration of Learning (rₙ) as a change in Velocity of Learning (vₙ). For instance, the change can be measured between successive actions (jₙ, jₙ₋₁), where rₙ=vₙ−vₙ₋₁. For instance, a high value of the Acceleration of Learning (rₙ) may indicate that the player is learning faster in the area of one or more of the Learning Assessments (e.g., INC, TAL, REL, INN, and LNG). Note, however, that the Acceleration of Learning can calculated differently by examining changes in the Velocity of Learning with respect to other factors. Such factors may be the resources used to overcome a challenge, the time taken to overcome a challenge, the number of attempts to overcome a challenge versus the number of failed attempts, and combinations of these factors.

Flow Charts

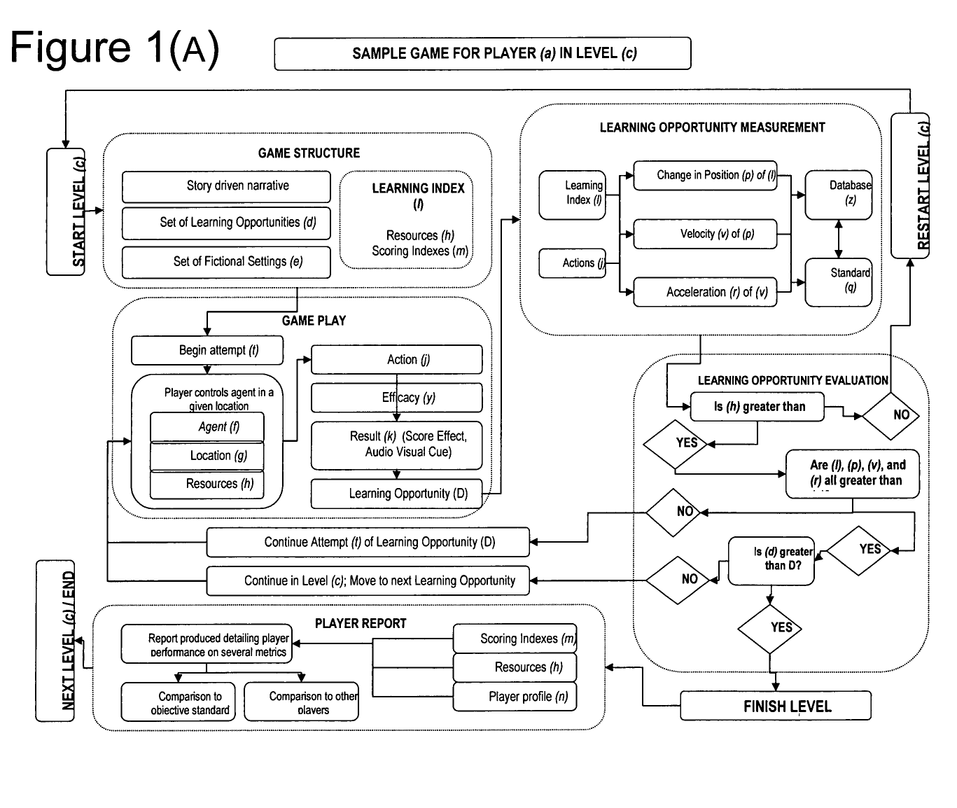

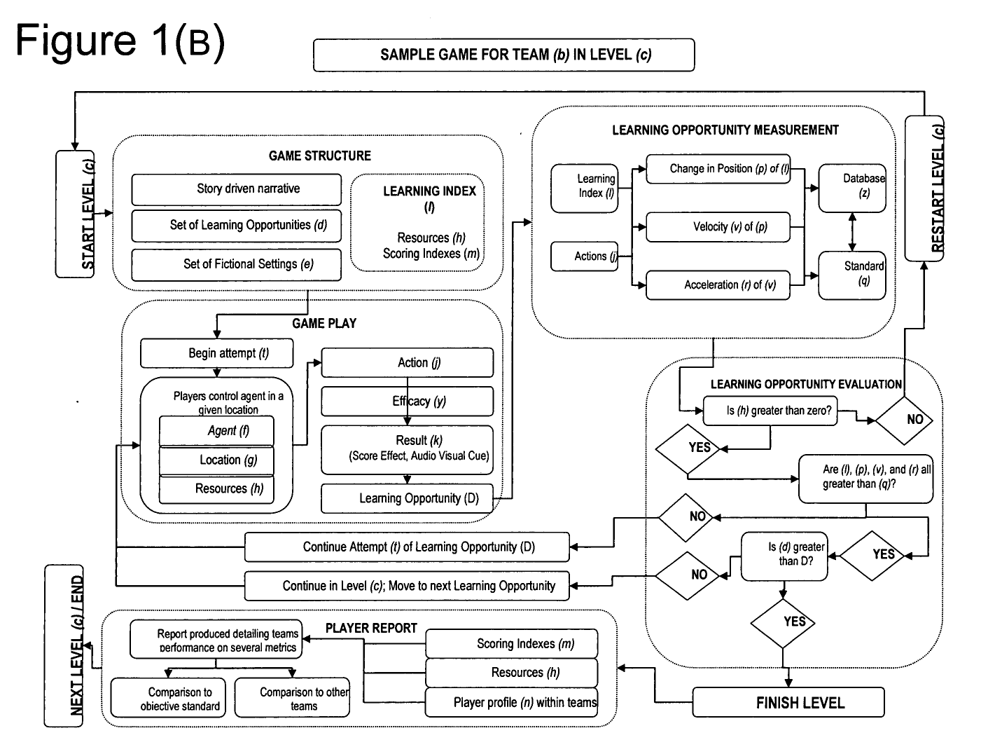

Variables used in the flowcharts of FIGS. 1A-1B have the following definitions:
Player (a)—One person playing the game with a singular goal; (a) goes from 1 to A.
Team (b)—A group of players (a) playing with a mutual goal; (b) goes from 1 to B.
Level (c)—A portion of a game with a beginning, middle and end; (c) goes from 1 to C.
Learning Opportunities (d)—A set of interactions in the game designed to produce learning in a player (a) or team (b); (d) goes from 1 to D. For each D, there is a standard (q) which goes from 1 to Q.
Fictional settings (e)—A fictional area with a defined number of locations (g) contained within it; (e) goes from 1 to E.
Agent (f)—A character in the game controlled by the player (a); (f) goes from 1 to F.
Location (g)—A place within the fictional setting (e) which agents (f) inhabit; (g) goes from 1 to G.
Resources (h)—Materials which agents (f) use to instigate actions (j); (h) goes from 1 to H. Hₐ is the actual number of resources consumed, and Hᵢ is the ideal number consumed.
Action (j)—An action (j) is defined as an input or sequence of inputs, which, when matched with a listing from a predetermined table, independent of or in combination with an elapsed amount of time, lead to some sort of result (k), which in turn has an effect on the player's scoring indexes. An action is instigated by an agent (f) inside a location (g) using resources (h) to achieve a result (k); (j) goes from 1 to J. Jₐ is the actual number of actions performed, and Jᵢ is the ideal number performed.
Result (k)—The outcome of an action (j), tempered by efficacy (y). Accompanied by an audio/visual cue and a change to one or more scoring indexes (m); (k) goes from 1 to K.
Learning Index (l)—The product of a player's (a) scoring indices (m), resource level (h); (l) goes from 1 to L. Formula for learning index is as follows: (M₁*M₂*M₃* . . . Mₙ)+(Hₐ−Hᵢ)
Scoring indexes (m)—Indices which relate to a particular element of the game being measured, such as Teamwork, leadership, skill development, etc; (m) goes from 1 to M.
Player profile (n)—A playing style determined by which actions (j) the player (a) chooses; (n) goes from 1 to N. For example, choosing Actions 4, 12 and 18 during Learning Opportunity 9 would indicate Playing Style A.
Change in Position (p)—Change of the Learning Index (l) during a particular Learning Opportunity (d), or ΔL; (p) goes from 1 to P. For example, Learning Index is 100 before encountering the learning opportunity (d), but is 110 afterwards. Change in Position would then equal 10.
Learning standard (q)—A predetermined objective standard set by game designers to measure whether learning has been achieved; (q) goes from 1 to Q. Standards can apply to (1), (p), (v) and (r). Standards must be achieved in order to advance to the next learning opportunity.
Acceleration (r)—Measurement of change of Velocity (v), or ΔV; (r) goes from 1 to R.
Attempts (t)—The initiation by a player (a) or team (b) of actions (j) in the effort to complete a learning opportunity (d); (t) goes from 1 to T.
Velocity (v)—Measurement of Change in Position (p); (v) goes from 1 to V. Formula for (v) is as follows: P/(Jₐ/Jᵢ)
Efficacy (y)—A score of between zero and 100, which determines the effectiveness of an action (j) which generates the result (k) through a combination of random number generation, proximity to event and amount of deployment of resources; (y) goes from 1 to Y.
Database (z)—Collection of measurements about how individuals and teams respond to Learning Opportunities over time. Used to measure player performance, compare to past performance and judge against a community of players; (z) goes from 1 to Z.

Given the foregoing definitions of variables, the following gives a discussion of an example of a video game in a single player application. The video game is played by player (a) skillfully choosing and performing an activity (s) to overcome each challenge presented by each learning opportunity (d). Each activity (s) expends scarce resources (h). When an activity (s) is chosen, a counter called an action (j) is incremented. During game play, action (j) increases and resources (h) decrease as player (a) makes an attempt (t) to complete learning opportunity (d). Attempt (t) is incremented each time that player (a) is unsuccessful at completing learning opportunity (d). Attempt (t) increases until player (a) successfully completes learning opportunity (d). The video game has several levels (1-C). Each level (c) has learning opportunities (1-D) staged in settings (1-E). Locations (1-G) are found within each setting (e).

The player's goal is to complete all learning opportunities (1-D) in all levels (1-C) to achieve a high score. More importantly, however, the video game is designed to assess the player's learning of certain key concepts and to place metrics on the dynamics of the player's learning. These metrics assess the skill with which player (a) chooses and performs each activity (s) in response to each challenge presented by each learning opportunity (d). Each challenge is designed to be an opportunity for the player to learn one or more of the key concepts. As such, the measurement of the player's skill in responding to challenges is analogous to the player's learning of the key concepts.

In each Learning Opportunity (d), the player's performance is measured by a Learning Index (l). As applied here, the Learning Index (l) is composed of a set of Scoring Indexes (m) each pertaining to the different elements of the key concepts of ITRIL (Income, Talents, Relationships, Innovations, and Longevity), and the player's Resource (h) usage level compared to what resources the player had at the beginning of the level (c).

In attempt (t), player (a) can choose an activity (s) to overcome a corresponding challenge in learning opportunity (d). In doing so, however, player (a) can exhaust resources (h=0) before the learning opportunity (d) is complete. If so, learning opportunity (d) is deemed to be incomplete and the attempt (t) is ended as a non-success. If player (a) chooses to make another attempt (t+1) to complete learning opportunity (d), there will be a replenishment of resources (h=Max) and player (a) continues game play from the beginning of learning opportunity (d) for the next attempt (t+1). Once player (a) completes learning opportunity (d), game play moves to the next learning opportunity (d+1), or moves to the next level (c+1) if there are not more learning opportunities (d=D) at level (c). Once all levels have been completed (c=C), the game is over.

I. Structure of Video Game Play

Player (a) will play Level (c) within the game “ITRIL Island”—either alone or simultaneously with other players (a). The Level (c) takes place within the Fictional Setting (e) of a tropical island. On this island are several different Locations (g), such as a hotel resort, a lagoon, a mountain top and a beach, etc. The level will resemble a story—that is, it will have a status quo (beginning), a crisis or complication (middle), and a resolution (end).

II. Player Goals

The goal is to navigate through the level (c) and complete a set of Learning Opportunities (d) without exhausting Resources (h). In this example, the overall goal will be to educate the player about the principles of “I.T.R.I.L.”, which represent each first letter of a management system composed of five elements: Income, Talents, Relationships, Innovation and Longevity.

III. Game Play

Player (a) will attempt to navigate through the level's (c) learning opportunities (d) by controlling a group of agents (f), including their own character and their staff, which composed of two different classes of agents, “ITRILites” and “Alphas.” These agents will help “Guests,” who are autonomous agents, enjoy their time on the island. Other agents (f), such as “Enemies,” are controlled by the computer and seek to disrupt or frustrate the player's (a) attempt to navigate through the level (c) and complete all available learning opportunities (d).

Player (a) will direct their Agents (f) to facilitate the “Guests” experience on the island and protect them against “Enemies” by engaging in certain Actions (j). These Actions (j) can include helping a guest to check into his or her hotel room, enjoy themselves on a “Jaunt” (trip to a different Location (g) within the Fictional Setting (e)), or combating an Enemy with a variety of Tools (t) at their disposal, such as a Converter, which converts Enemies into ITRILites, a Discounter, which lowers the prices for any affected Guest, or a Power-Up, which renders ITRILites and Alphas invulnerable temporarily.

IV. Actions

An action (j) is defined as an input or sequence of inputs, which, when matched with a listing from a predetermined lookup table, independent of or in combination with an elapsed amount of time, lead to a result (k), which in turn has an effect on the player's scoring indexes.

Each Action (j) also requires the use of Resources (h), which are given to the player in pre-determined amounts before the level (c) begins. Resources (h) can range from, for example, an objectively determined amount of cash or Currency to a more subjective concepts such as Boosts (inspirational devices which make ITRILites and Alphas better able to withstand attack from enemies) or Bliss (which increase emotional satisfaction levels for both Guests and Staff).

V. Efficacy

Depending on player performance and decision-making, each action (j) has a range of potential efficacy (y), expressed numerically from 0 to 100. Since each action (j) has associated conditions and factors contingent on its effective execution, actions (j) can potentially affect a player's (a) scoring indexes (m), learning index (l) or resource (h) use in different ways. An action (j) with a high efficacy will result in a greater score than one with less efficacy (y)—and in fact, actions with low efficacy (y) can even negatively affect scoring indexes (m).

Efficacy (y) is determined by referring to a lookup table to see if the player triggered any relevant conditions during the action (j). If so, the efficacy (y) is calculated and factored into the action's (j) effect on the scoring index (m).

VI. Results

After an action has been completed, a Result (k) is then generated, which is accompanied by a resultant effect on both Scoring Indexes (m) and resources (h). A Result (k) is accompanied by audio/visual cue to tell the player what has happened because of their Action (j).

VII. Learning Opportunities

Contained within the level (c) is a set number of Learning Opportunities (d), which the player must confront before completing the level (c). For example, a player must complete a Jaunt with Guests without having it be ruined by Enemies. This consumes Resources (h) along the way, and requires the player to direct his Staff to protect Guests from harm.

In this Learning Opportunity (d), the player's performance is measured by a Learning Index (l). The Learning Index (l) is composed of a set of Scoring Indexes (m) each pertaining to the different elements of ITRIL and the player's Resource (h) level compared to what they had at the beginning of the level (c).

In this example using our “ITRIL” measurements of Income, Talents, Relationships, Innovations and Longevity, each Action (j) a player makes will have a resultant score effect on one or more of those five measurements, also known as Scoring Indexes (m). This score effect will have the amount of resources (h) a player is judged to have wasted during those actions subtracted from it. The equation for the Learning Index is thus:
[Scoring Indexes]+{[Actual Resources]−[Ideal Resources]}
and in this specific case, is described as:
{[Income Index]*[Talents Index]*[Relationship Index]*[Innovation Index]*[Longevity Index]}+{[Actual Resources]−[Ideal Resources]}

For example, the abstract and subjective notion of “Guest Satisfaction” is linked to several of these Scoring Indexes: Income (if guests are more satisfied, they will return more often), Relationships (satisfied guests will become more loyal customers) and Longevity (more loyal customers means a greater chance of the hotel staying in business for a longer period of time).

The example action of “Delivering Room Service to a Guest's Room” consumes perhaps 2 resources—say, the staff's energy level—but none of these are judged to have been wasted (i.e., with maximum efficacy). This action raises Income by 3%, Relationships by 2% and Longevity by 1%. If each ITRIL score and resource level were at 100% at the beginning, the equation would change:
from:

$$\begin{matrix}Inc . & Tal . & Rel & Inn . & Lng . \\ \{ 100 \% * & 100 \% * & 100 \% * & 100 \% * & 100 \% \} +\end{matrix}$$

$$Resources \{ 100 \% - 100 \% \} = 100 \%$$

to:

$$\begin{matrix}Inc . & Tal . & Rel & Inn . & Lng . \\ \{ 103 \% * & 100 \% * & 102 \% * & 100 \% * & 101 \% \} +\end{matrix}$$

$$Resources \{ 98 \% - 98 \% \} = 106 \%$$

The Learning Index is now 106 instead of 100.
However, if the action had been judged to have wasted 3% of resources, resulting in a value of ‘5’ for energy being used instead of a value of ‘2’, the equation would have looked like this:

$$\begin{matrix}Inc . & Tal . & Rel & Inn . & Lng . \\ \{ 103 \% * & 100 \% * & 102 \% * & 100 \% * & 101 \% \} +\end{matrix}$$

$$Resources \{ 95 \% - 98 \% \} = 103 \%$$

The Learning Index is therefore 103 instead of 100. And if the action had been judged unsuccessful—that is, the Guest had actually become MORE unsatisfied by the delivery—the wrong food, for example—and had a minimum efficacy, lowering the Scoring Indexes by the same amounts, the result would have been:

$$\begin{matrix}Inc . & Tal . & Rel & Inn . & Lng . \\ \{ 97 \% * & 100 \% * & 98 \% * & 100 \% * & 99 \% \} +\end{matrix}$$

$$Resources \{ 95 \% - 98 \% \} = 91 \%$$

The Learning Index would have dropped to 91 instead of 100. Thus, a subjective notion, such as ordering room service, can be converted into objectively determinable mathematical formulas for the purposes of this video game.

As stated above, in confronting the Learning Opportunity (d), a player conducts a number of Actions (j) which affect his Learning Index (l), which is derived from his Resource (h) levels and Scoring Indexes (m), which are composed from the “ITRIL” management system. From those variables, we can derive Change in Position (p), Velocity (v) and Acceleration (r). Each of these, (l), (p), (v) and (r), are all measured against a Standard (q). The Standard is set from consulting a Database (z), which contains information on past game play and general population statistics related thereto. If (l), (p), (v) and (r) all meet the required standard (q), then the Learning Opportunity (d) has been completed. If not, the player must continue in the Learning Opportunity or end the game if his Resources (h) have been exhausted.

For example, a player (a) tries to complete the Learning Opportunity (d) of taking Guests on a successful Jaunt. While completing the various tasks of the Jaunt—transporting the guest to and from the Location (g) and using Tools (t) to fend off Enemies—the player generates a set of metrics.

VIII. Standards

To complete learning opportunities (d), standards (q) must be exceeded by players (a). Standards (q) are derived by consulting the Database (z) to check the range of results various players (a) have achieved when confronting learning opportunities (d) in the past. The standards (q) are calculated by referencing a certain percentage of those results, then requiring players (a) to exceed that percentage.

For example, in this particular learning opportunity (q), it is determined that in order for a player to achieve “success,” they must get a higher score than 75% of the population at large. By consulting the database (z), we can see that 75% of the population scored a Learning Index (l) of less than 200, a final Change in Position (p) of less than 25, a Velocity (v) of less than 10 and an Acceleration (r) of less than 15. Therefore, the player (a) must meet or exceed all of these standards (q) in order to complete the Learning Opportunity (d).

If the standards (q) have been met, then the question is asked: are there any more Learning Opportunities (d) available in the level (c)? If so, the player continues through the same process completing other Learning Opportunities (d)—taking Guests on more complex Jaunts, managing customer expectations, training new staff, defeating enemies—until the Learning Opportunities (d) have been exhausted.

If the standards (q) have been met, then the question is asked: are there any more Learning Opportunities (d) available in the level (c)? If so, the player continues through the same process completing other Learning Opportunities (d)—taking Guests on more complex Jaunts, managing customer expectations, training new staff, defeating enemies—until the Learning Opportunities (d) have been exhausted.

IX. Exemplary Walk for a Single Player

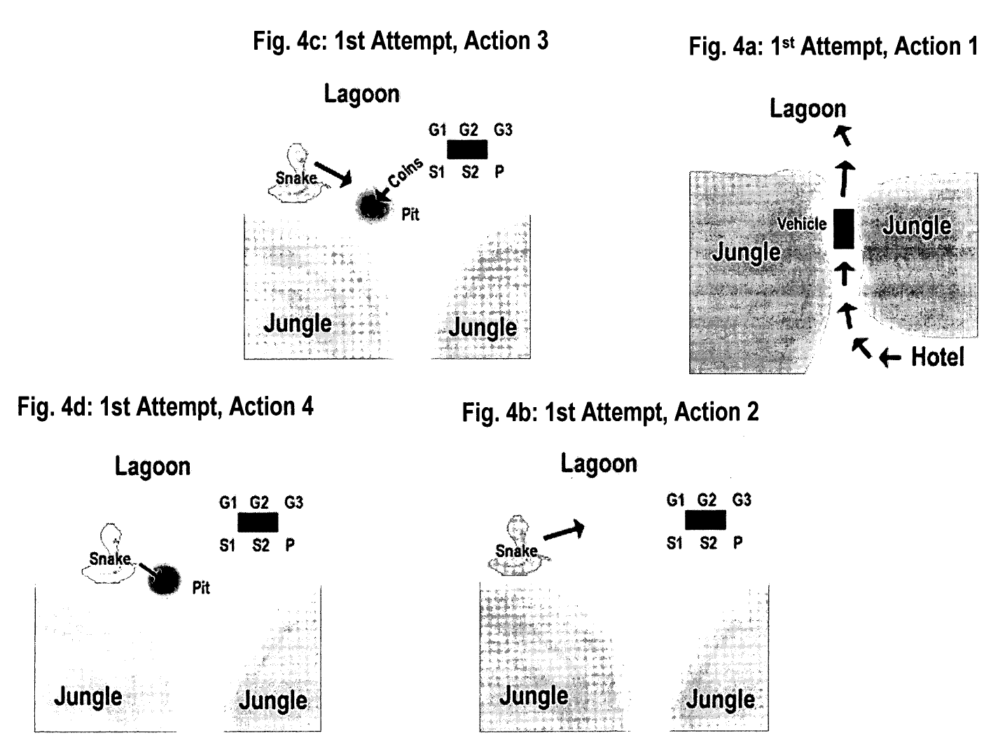

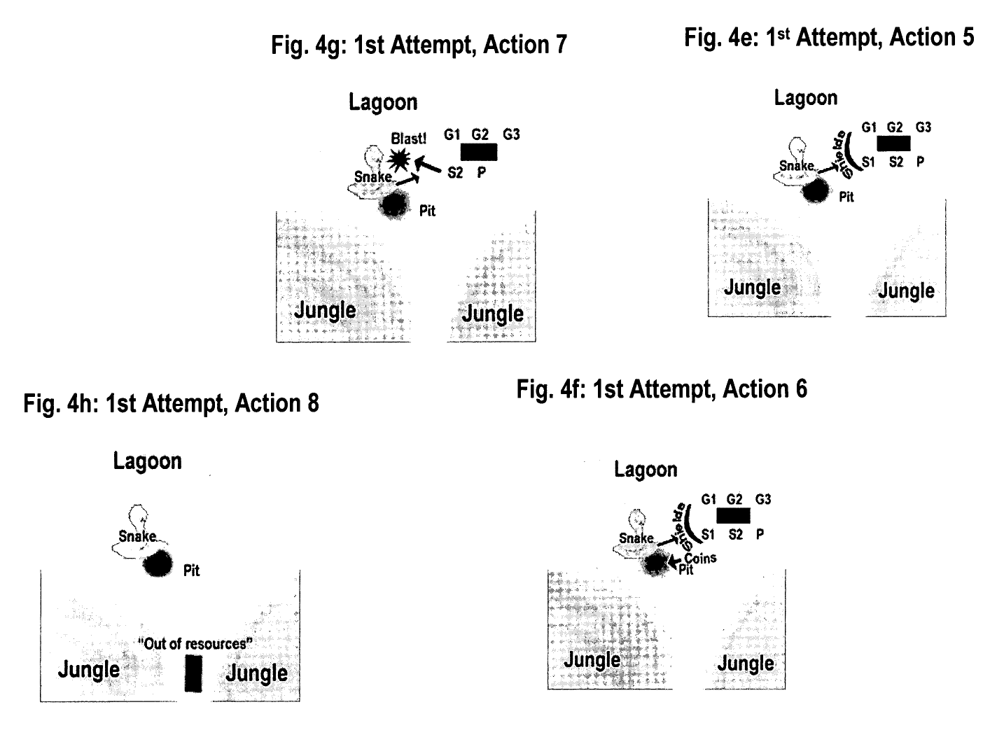

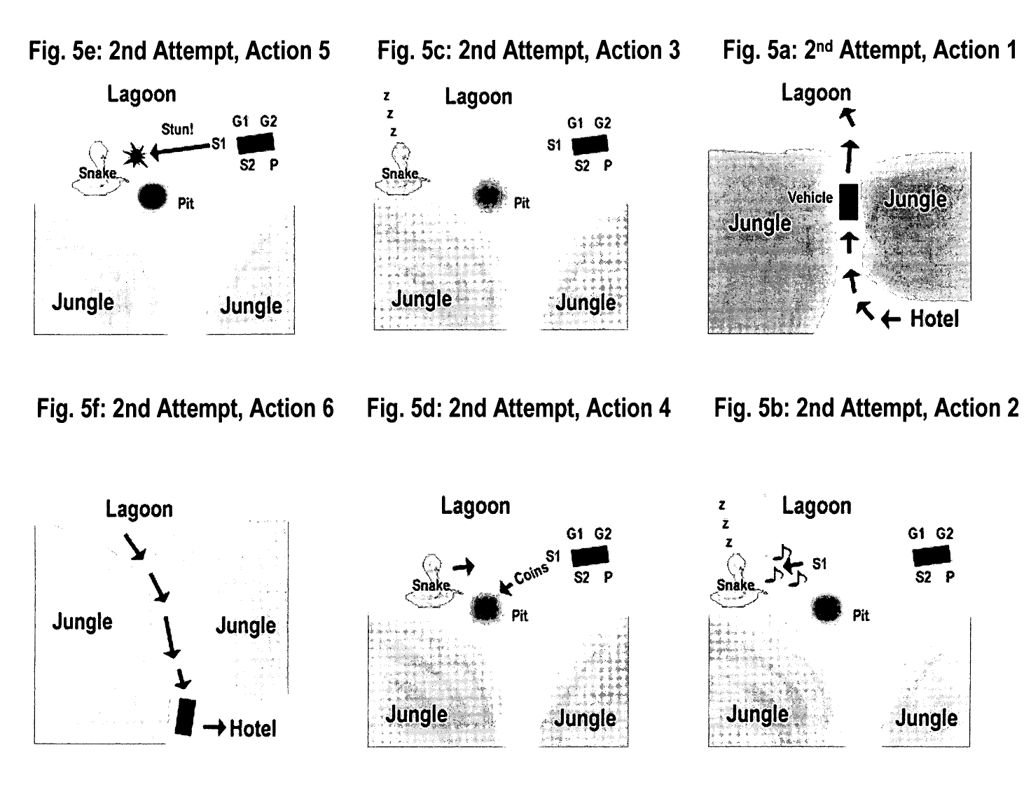

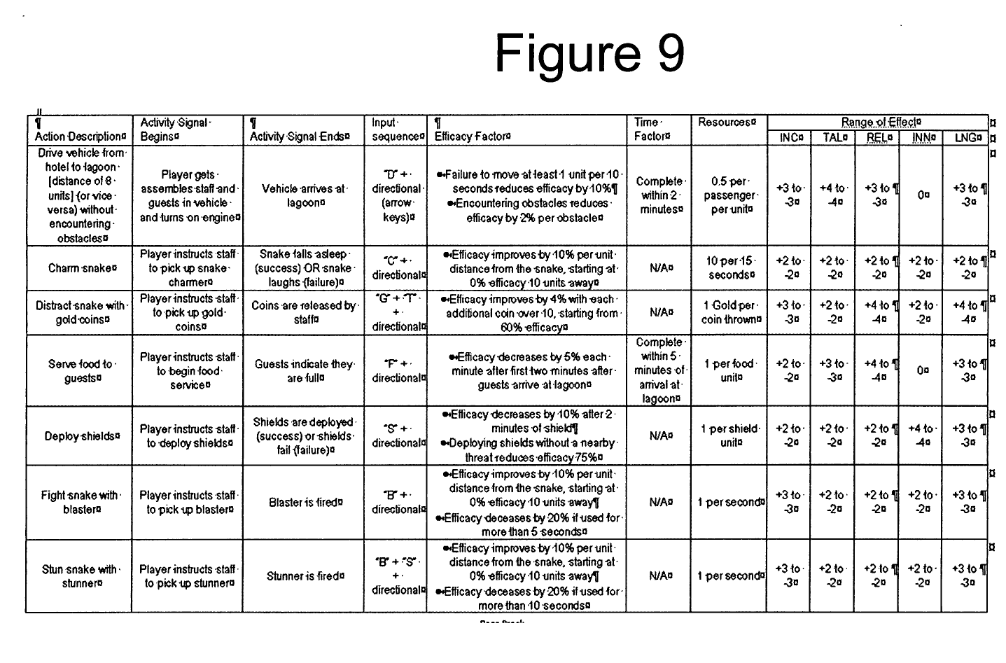

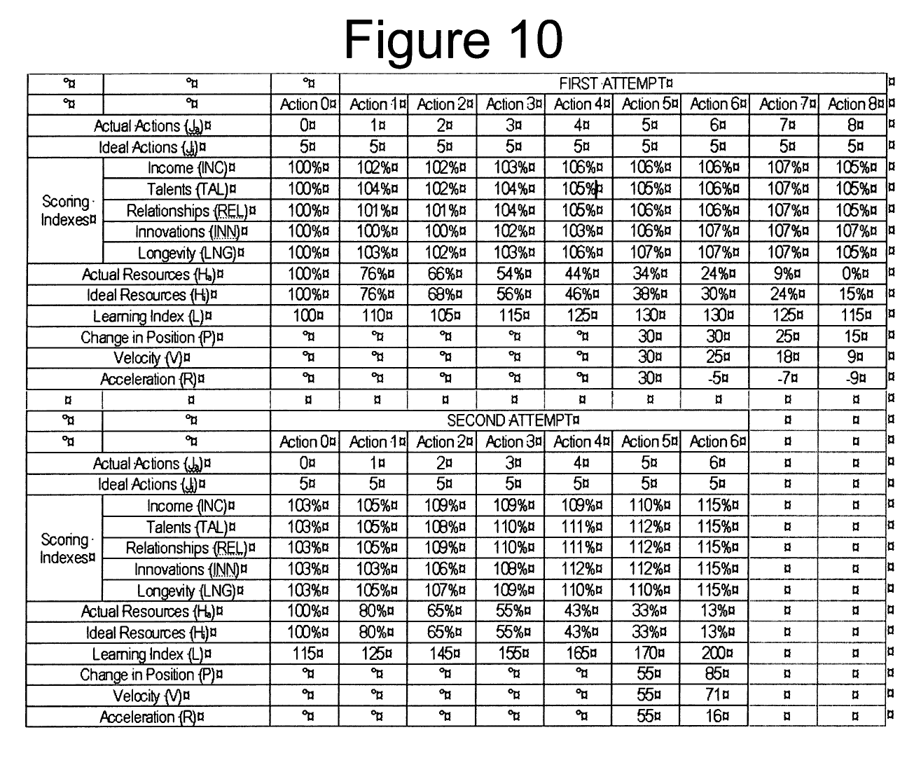

In this example of a ‘walk through’ an exemplary video game, reference is made to activities and actions when attempting to overcome a challenge in the video game. Reference is also made to the table in FIG. 10 showing calculations, using the formulas in the table of FIG. 9, for a player's sequential actions in first and second attempts to overcome a challenge. Note also that the player's sequential actions in the first and second attempts, discussed below, are depicted respectively in FIGS. 4a-4h and FIGS. 5a-5f.

A Player (a) is charged with a Learning Opportunity (d): transporting Guests from the Location (g) of the Hotel to the Location (g) of the Lagoon for an enjoyable afternoon and back again without being devoured by a Snake. Player (a) has 100 resources (h) to accomplish this task, which can be expended via Gold Coins, Fuel, Food, Shields or Weapons. Player (a) can engage in actions (j) such as Protect, Fight, Move or Deceive. also direct agents (f) such as staff to engage in similar actions (j). In this example, the Standards (q) are a Learning Index (l) of 200, a Change in Position (p) of 25, a Velocity (v) of 10 and an Acceleration (r) of 15. The Scoring Indexes are based on Income (INC), Talent (TAL), Relationships (REL), Innovation (INN) and Longevity (LNG). This particular learning opportunity (d) has an ideal number of 5 actions required to solve it—that is, no fewer than 5 actions will result in success. Thus, Change in Position, Velocity and Acceleration will not be calculated until the first 5 actions are complete.

A sample lookup table of actions is provided, as well as each action's range of resultant effect, depending on the efficacy (y) of the action (j). Any action can also be judged through its efficacy rating as to have wasted resources (h).

Once all four standards have been met, and the player is judged to have mastered the Learning Opportunity. Learning has therefore occurred because measurable improvements in player performance have been shown via variables directly related to player input, as judged against an objective standard based on the performance of a larger population.

X. Finishing the Level

Once either the player has run out of Resources (h) or has exhausted all Learning Opportunities (d), the player has finished the level (c). At this point, the player moves on to the next level (c) or, if there are no more levels (c), has completed the game.

XI. Player Reports

A Report is then generated for the Player (a) and/or their supervisor which details the types of decisions made by the Player (as revealed in their “Player Profile” (n)); the amount of Resources (h) used relative to the amount they began the level (c) with; and the Scoring Indexes (m), which show the sum total of the effects their Actions (j) and Results (k) had on their “ITRIL score.”

If the Player (a) has Actions 1 through 20 to choose from during a Learning Opportunity (d), and chooses Actions 4, 13 and 18, these choices may indicate a ‘Playing Style A’. Action 4 is to have ITRILites attack the Enemies directly, Action 13 is to shorten the Jaunt's duration at the expense of Guest satisfaction and Action 18 is to expend resources on Power-Ups for their staff. Given these choices, the Playing Style A may be determined in that it shows Player (a) to have an “Aggressive/Surrender” playing style. If they choose another set of actions—to increase the Brain level of the Staff, to invest resources in a faster level of transport for Guests to and from the Jaunt and to use a Converter on the Enemies, then that is a “Differentiator/Conversion” playing style.

For example, each action will also have presumed to have a particular style of play associated with it. Some actions could be branded as “Creative” actions, some as “Emotional” actions, and some as “Action” actions. The report can be used to determine which style of actions a player tends to choose.

The Report will show the player (a) how they performed both compared to an objective standard of player performance as well as how they performed compared to other players' scores using the Database (z) as a guide.

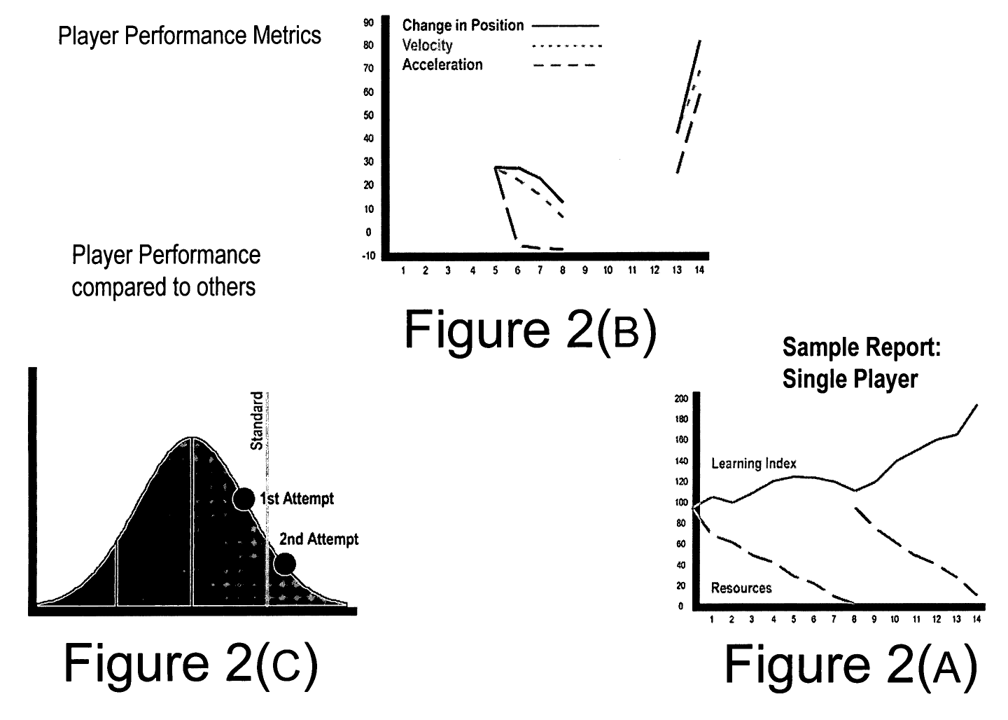

A sample report is attached as graphs in FIG. 2A-2C for a single player:
Player Name: John Q. Public
Learning Opportunities: Lagoon Jaunt (2 Attempts)
Player Profile:
   Temperament 61% Action, 24% Creativity, 15% Emotion
   ITRIL Score Income 34%, Talents 56%,
   Relationships 45%, Innovation 77%,
   Longevity 82%

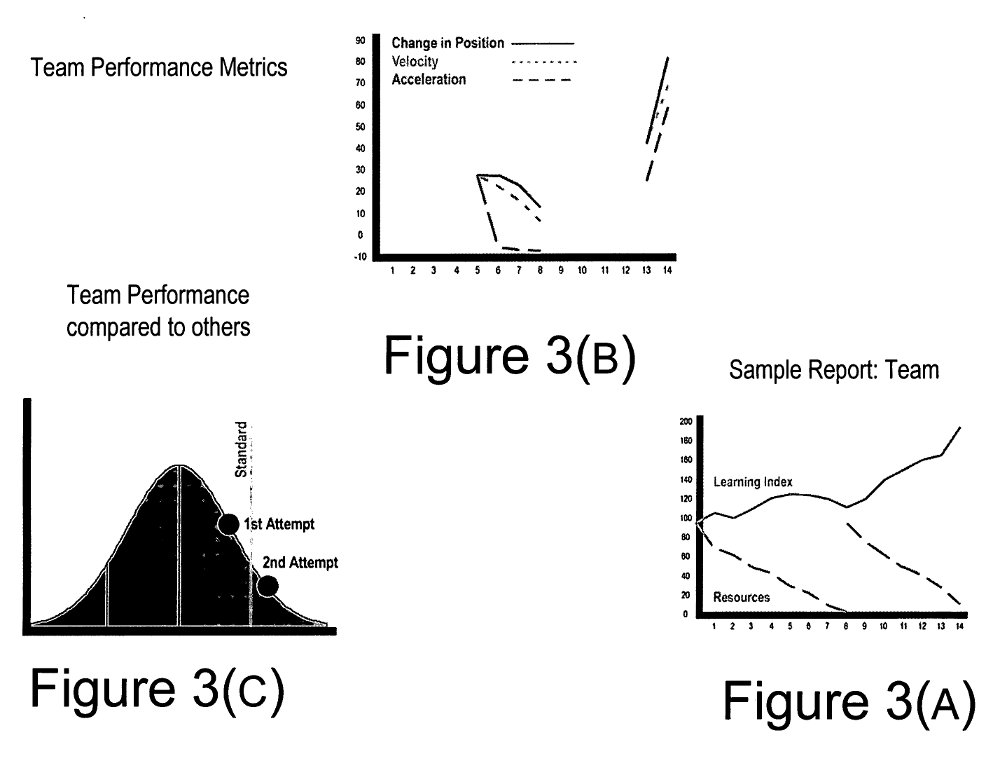

A sample report is attached as graphs in FIGS. 3A-3C for a team of players:
Team Name: Team Generic
Players: John Q. Public (1), Jane Q. Public (2)
Roger B. Hayes (3), C. A. Arthur (4)
Learning Opportunities: Lagoon Jaunt (2 Attempts)
Team Profile:
   Temperament 61% Action, 24% Creativity, 15% Emotion
   ITRIL Score Income 34%, Talents 56%,
   Relationships 45%, Innovation 77%,
   Longevity 82%

1^{st} Attempt: FIG. 4a-4h

Respective screen shots, discussed below, are shown for each successive action taken by a single player during a first attempt to overcome a challenge (e.g., satisfy a game condition) in a video game that is designed to teach the players to provide good guest services in the operation of a vacation property.

FIG. 4a: 1^{st} Attempt, Action 1: Player (a) moves 3 Guests and 2 staff members into Vehicle and transports them to Lagoon. Trip consumes 4 Fuel resource (h) units per passenger, so six passengers total consumes 24 resources (h). Passengers enjoy trip as it went relatively quickly, resulting in rising satisfaction score, raising learning index (l) from 100 to 110. Resources (h) now at 76.

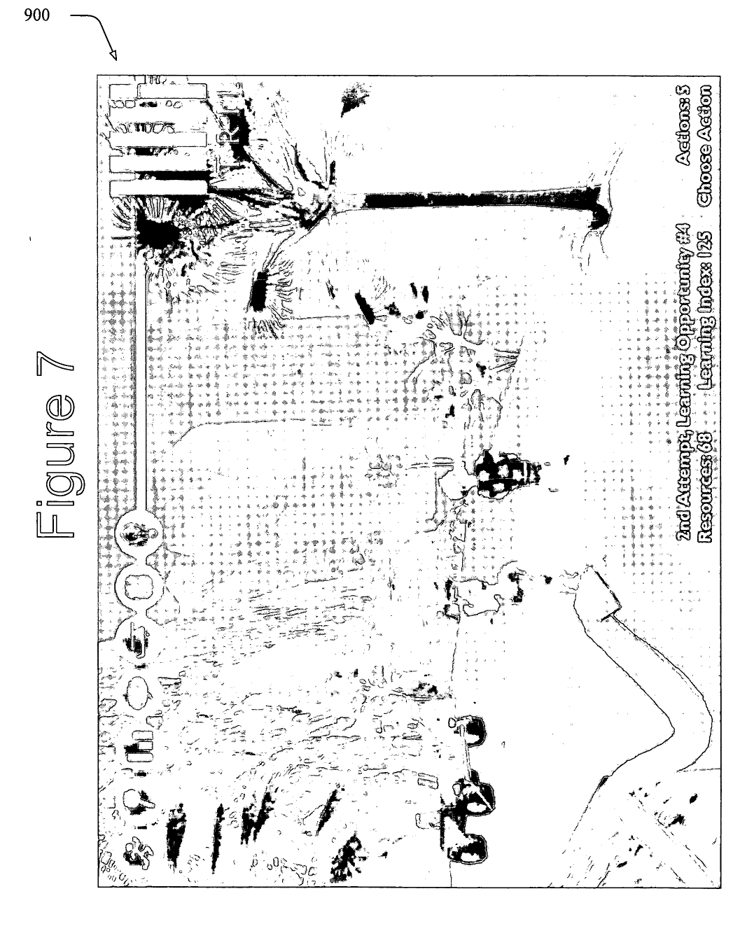

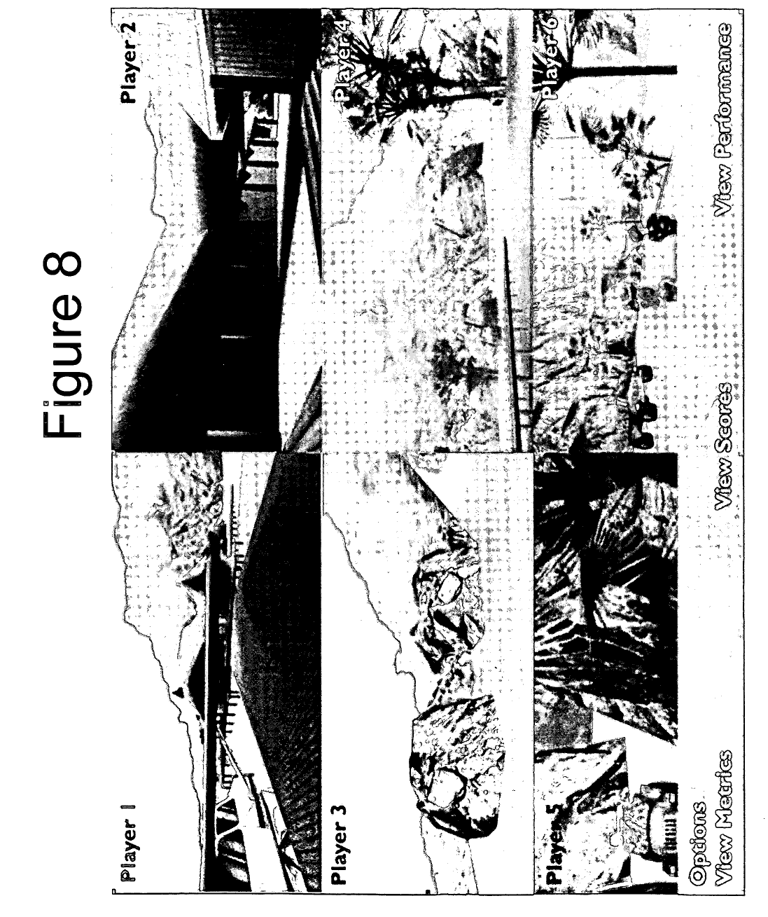

FIG. 4b: 1^{st} Attempt, Action 2: Group reaches Lagoon, begins to enjoy themselves. Snake is encountered, but it is sleeping. Staff is dispatched to try and get rid of the snake. 10 resources (h) are used in the form of a Weapon, an electric snake charming machine. The staff's charming is not effective, however, and the snake begins to move towards the guests as seen in FIG. 7 from the perspective of the agent being controlled by the Player (a). Note that FIG. 8 shows other screen shots of the video game in which a vacation of resort theme is present. At the appearing of the snake, the Guests become frightened, lose 5 learning index (l) from 110 to 105. Resources (h) now at 66.

FIG. 4c: 1^{st} Attempt, Action 3: Player tells another staff member to deceive the snake by throwing 12 gold coins (consuming 12 resources (h)) over into a dark pit. The snake is intrigued and goes to investigate. Guests become more at ease, gain 10 learning index (l), up to 115. Resources (h) now at 54.

FIG. 4d: 1^{st} Attempt, Action 4: Staff dispatched to attend to guests, giving them 10 resources (h) worth of Food to enjoy while Snake is distracted. Guest satisfaction level rises, causing learning index (l) to rise to 125. Resources now at 44.

FIG. 4e: 1^{st} Attempt, Action 5: Snake now smells food, starts coming closer to investigate. Guests start freaking out, but Player (a) tells Staff puts up 10 resources (h) worth of Shields to guard against the snake. Guests relieved, learning index (l) rises to 130, but Resources down to 34. Change in Position (p), Velocity (v) and Acceleration (r) are all now calculated for the first time—all are at 30.

FIG. 4f: 1^{st} Attempt, Action 6: Guests, being afraid of the snake despite the Shield, are ready to cut short their afternoon at the Lagoon and head back to the hotel. Player (a) directs a Staff member to throw another 10 gold coins to Deceive the Snake, while the Guests climb into the Vehicle. The ruse works, yet the Guests are too busy climbing into the Vehicle to raise the player's Learning Index (l), which stays at 130. Resources (h) down to 24, Change in Position (p) stays at 30, Velocity (v) drops to 25, Acceleration (r) goes to −5.

FIG. 4g: 1^{st} Attempt, Action 7: Snake devours Staff member dispatched to throw the gold coins, and begins chasing after the vehicle. With only 24 resources (h) remaining, and 5 passengers, player (a) must either consume more fuel to try and outrun the snake, or use a weapon to try and Fight the snake. Player (a) chooses to Fight, choosing a Blaster gun, which consumes 15 resources but satisfies a predetermined game condition so as to be successful. However, the guests are dismayed by the violent tactics used, and the player's learning index (l) drops 5 as a result to 125. Change of Position (p) is now 25, Velocity (v) is 21, and Acceleration (r) is −9.

FIG. 4h: 1^{st} Attempt, Action 8: Player now drives back to the hotel, but only have 9 resources (h) left—not enough to make it with 5 passengers. Therefore, player runs out of resources (h), and learning index (l) drops 10 to 115 due to guest dissatisfaction at being stranded in the jungle. Player is forced to restart.

2^{nd} Attempt: As the player (a) begins the second attempt, the learning index (l) stays at 115 to reflect the player's first attempt at learning. The goals are still the same as the first attempt.

FIG. 5a: 2^{nd} Attempt, Action 1: Player (a) moved 2 Guests and 2 staff members into Vehicle and transports them to Lagoon, consuming 20 fuel resources (h). Passengers enjoy trip, raising learning index (l) from 115 to 125. Resources (h) now at 80.

FIG. 5b: 2^{nd} Attempt, Action 2: Player (a) tells Staff to charm snake again using 15 resources (h), which succeeds-snake falls asleep. Guests are happier-learning index (l) rises to 145. Resources (h) drop to 65.

FIG. 5c: 2^{nd} Attempt, Action 3: Player (a) tells Staff to feed 10 food resources to the guests, consuming 10 resources (h). Learning index (l) rises to 155, resources (h) drop to 55.

FIG. 5d: 2^{nd} Attempt, Action 4: Player (a) throws coins towards a pit to distract the snake away from the guests, consuming resources (h) to effect a drop to 43 but causing Learning index (l) to rise to 165.

FIG. 5e: 2^{nd} Attempt, Action 5: Staff directed to stun snake with Stunner tool, which succeeds. Guests continue to relax and enjoy the lagoon, which raises the learning index (l) to 170. Stunner costs 10 resources (h), leaving 33 remaining. Change in Position (p), Velocity (v) and Acceleration (r) all at 55.

FIG. 5f: 2^{nd} Attempt, Action 6: Guests are satisfied with the snake-free Lagoon experience, and are ready to go home. Trip back to hotel takes 20 resources (h), leaving 13 remaining. Learning Index (l) rises to 200 thanks to return bonus, while Change in Position (p) rises to 85, Velocity (v) to 71, and Acceleration (r) to 61.

Video Game Machine

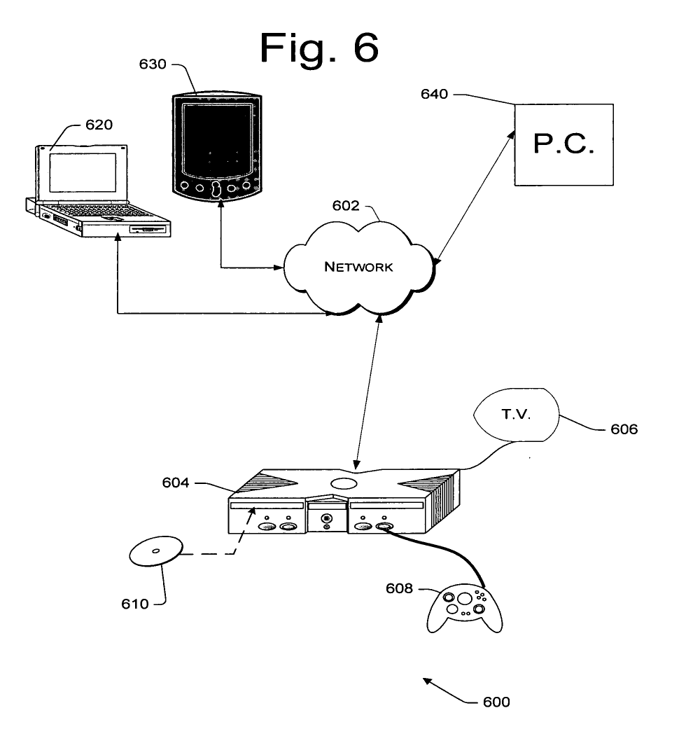

FIG. 6 illustrates non-limited examples of exemplary gaming systems 600 including a video game console, 604, a laptop computer 620, a personal digital assistance 630, and a personal computer 640, where each gaming system has an input device and a display. Other contemplated gaming system platforms (not shown) include a cellular telephone, a workstation, a server, a set top box, and a handheld computing device.

A network 602 allow player vs. player and team play of a video game on one or more of the gaming systems 604, 620, 630, and 640. The game console 604 is equipped with an internal hard disk drive and a portable media drive for reading various forms of portable storage media bearing digital data as represented by optical storage disc 610. Examples of suitable portable storage media include game discs, game cartridges, and so forth. A controller 608 is in communication with game console 604 and is equipped with one or more thumb sticks, a directional or D-pad, surface button, and two triggers. These mechanisms are merely representative, and other known gaming mechanisms may be substituted.

The gaming system 604 may be operated as a standalone system by simply connecting the system to a television or other display 606. In this standalone mode, the gaming system 604 allows one or more players to play games. However, with the integration of network connectivity made available through the network 602, the gaming system 604 may further be operated as a participant in a larger network gaming community by using of a local area network or the Internet. In another implementation, the gaming system 604 can be used in a larger gaming community by directly connecting the gaming system 604 to another gaming system. In this other implementation, rather than using of a local area network or the Internet, the direct connection can be made by an electrical cable to ports on the respective gaming systems (not shown).

Video games may be stored on various storage media for play on the game console. For instance, a video game may be stored on the portable storage disc 610 or the video game may be stored on the internal hard disk drive of system 604, being transferred from a portable storage medium or downloaded from a network.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. Any video game teaching a player through game play and assessing the player's learning of the teaching, wherein a determination is made as to how fast the player is learning and whether the player is learning faster.

2. Any video game of claim 1, wherein:
the player's learning assessment is used to determine how fast the player is learning; and
the determination of how fast the player is learning is used to determine whether the player is learning faster.

3. Any video game of claim 1 that reports one or more of the following: the player's learning assessment, how fast the player is learning, and whether the player is learning faster.

4. Any video game of claim 1 that reports, for each of a plurality of players, the player's learning assessment, how fast the player is learning, and whether the player is learning faster.

5. Any video game of claim 1, wherein:
the player plays the video game against another player; and
a comparison between the players made with respect to the player's learning assessment, how fast the player is learning, and whether the player is learning faster.

6. Any video game of claim 1, wherein:
the player plays the video game on a team with players; and
a comparison is made, between team players, with respect to the player's learning assessment, how fast the player is learning, and whether the player is learning faster.

7. Any video game of claim 5, wherein:
a derivation is made of a team learning assessment, how fast the team is learning, and whether the team is learning faster; and
the derivation is made using each player's learning assessment, how fast each player on the team is learning, and whether each player on the team is learning faster.

8. Any video game of claim 7, wherein the team's learning assessment is used to determine how fast the team is learning and the determination of how fast the team is learning is used to determine whether the team is learning faster.

9. Any video game of claim 7, wherein:
the team plays the video game against another team of players;
a comparison is made, between teams, with respect to the team's learning assessment, how fast the team is learning, and whether the team is learning faster.

10. Any video game of claim 9, wherein the video game determines at least one of:
the player with the highest player's learning assessment of any player on any team;
the player with the highest player's learning assessment of any player on the player's team;
the team with the highest team's learning assessment;
the team that learns the fastest;
the player that learns the fastest of any player on the player's team;
the player that learns the fastest of any player on any team;
the team that is learning faster than any other team;
the player that is learning faster than any player on the player's team; and
the player that is learning faster than any player on any team.

11. Any video game of claim 1, wherein the player's learning assessment is a function of the player's performance in playing the video game so as to satisfy a predetermined game condition;

12. In a video game in which a player's performance in playing the video game provides input to the video game, a method comprising:
presenting to the player a challenge that is overcome when the player's input satisfies a predetermined game condition;
receiving input from the player in a plurality of attempts to overcome the challenge; and
for each attempt:
deriving a learning award as a function of the input received from the player to overcome the challenge; and
deriving a learning velocity as a function of:
change in the learning award derived for another said attempt; and
the number of attempts.

13. The method as defined in claim 12, wherein, for each said attempt, the learning velocity is derived by dividing the learning award by the number of the attempt.

14. The method as defined in claim 12, further comprising, for each attempt, deriving a learning acceleration as a function of change in the learning velocity.

15. The method as defined in claim 13, further comprising, for each attempt, deriving a learning acceleration as a function of change in the learning velocity.

16. The method as defined in claim 14, wherein, for each said attempt, the learning acceleration is derived by dividing the learning velocity by the number of attempt.

17. The method as defined in claim 15, wherein, for each said attempt, the learning acceleration is derived by dividing the learning velocity by the number of attempt.

18. The method as defined in claim 12, wherein the derivation of the learning award is also a function of resources used by the player to the player to overcome the challenge.

19. The method as defined in claim 12, wherein the derivation of the learning award is also a function of a difference between an amount of resources used by the player to the player to overcome the challenge and a predetermined amount of resources.

20. The method as defined in claim 12, wherein:
for each said attempt, the input received from the player to overcome the challenge initiates one or more activities; and
the derivation of the learning velocity is also a function of the number of activities.

21. The method as defined in claim 12, wherein:
the derivation of the learning award is also a function of resources used by the player to the player to overcome the challenge;
for each said attempt, the input received from the player to overcome the challenge initiates one or more activities; and
the derivation of the learning velocity is also a function of the number of activities.

22. The method as defined in claim 12, wherein the input received from the player in each said attempt to overcome the challenge is subjected to a psychometric test by use of a psychological measurement to derive the learning award.

23. The method as defined in claim 12, further comprising rendering a report of the learning velocity.

24. The method as defined in claim 14, further comprising rendering a report of the learning acceleration.

25. One or more computer-readable media comprising computer-executable instructions that, when executed, perform the method of claim 12.

26. A video game system comprising:
a game console having memory and a processor;
an input device compatible with the game console;
a video game executed on the game console and receiving input from the input device to control one or more player-selected activities, wherein:
the one or more player-selected activities are initiated in respective one or more attempts to satisfy a predetermined game condition;
when the one or more player-selected activities of one said attempt satisfies the predetermined game condition, the video game executed on the game console:
derives a learning award as a function of the control of the one or more player-selected activities; and
derives a learning velocity as a function of:
change in the learning award derived for another said attempt; and
the number of attempts.

27. The video game system as defined in claim 26, wherein, for each said attempt, the learning velocity is derived by dividing the learning award by the number of the attempt.

28. The video game system as defined in claim 26, further comprising, for each attempt, deriving a learning acceleration as a function of change in the learning velocity.

29. The video game system as defined in claim 27, further comprising, for each attempt, deriving a learning acceleration as a function of change in the learning velocity.

30. The video game system as defined in claim 28, wherein, for each said attempt, the learning acceleration is derived by dividing the learning velocity by the number of attempt.

31. The video game system as defined in claim 29, wherein, for each said attempt, the learning acceleration is derived by dividing the learning velocity by the number of attempt.

32. The video game system as defined in claim 26, wherein the derivation of the learning award is also a function of resources used to satisfy the predetermined game condition.

33. The video game system as defined in claim 26, wherein the derivation of the learning award is also a function of a difference between an amount of resources used to satisfy the predetermined game condition and a predetermined amount of resources.

34. The video game system as defined in claim 26, wherein, for each said attempt, the derivation of the learning velocity is also a function of the number of player-selected activities taken to satisfy the predetermined game condition.

35. The video game system as defined in claim 26, wherein:
the derivation of the learning award is also a function of resources used to satisfy the predetermined game condition; and
for each said attempt, the derivation of the learning velocity is also a function of the number of player-selected activities taken to satisfy the predetermined game condition.

36. The video game system as defined in claim 26, wherein, for each said attempt, the control of the one or more player-selected activities to satisfy the predetermined game condition is subjected to a psychometric test by use of a psychological measurement to derive the learning award.

37. The video game system as defined in claim 26, further comprising rendering a report of the learning velocity.

38. The video game system as defined in claim 28, further comprising rendering a report of the learning acceleration.

39. The video game system as defined in claim 26, wherein the game console is selected from the group consisting of a PC, a workstation, a server, a set top box, a video game console, a PDA, a cellular telephone, and a handheld computing device
